(19) United States
(12) Patent Application Publication
(10) Pub. No.: US 2012/0189174 A1
(43) Pub. Date: Jul. 26, 2012

(54) ELECTRONIC DEVICE AND WARNING INFORMATION GENERATING METHOD THEREOF

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/159,433

(22) Filed: Jun. 14, 2011

(30) Foreign Application Priority Data
Jan. 25, 2011 (CN) 201110026805.X

(51) Int. Cl. G06K 9/00

(52) U.S. Cl. 382/128

(57) ABSTRACT

The disclosure provides an electronic device and a method of generating warning information. The device includes a capturing unit, a storage unit, a control unit, and a display unit. When the capturing unit takes a photo, the control unit processes the photo to generate an image profile, compares to stored healthy images to determine a body part, acquires an unhealthy image and the parameter of the unhealthy image from the storage unit according to the body part, analyzes the body part to obtain the parameter of the body part, compares to the parameter of the unhealthy image to obtain a comparison value, and evaluates whether the comparison value falls within a predetermined range. If yes, the control unit acquires warning information from the storage unit associated with the unhealthy image and the display unit displays the warning information.

### BACKGROUND

1. Technical Field

The present disclosure relates to electronic devices and, particularly, to an electronic device with a function of generating health warnings, and a method of generating health warnings implemented by the electronic device.

2. Description of Related Art

On account of the fast pace of life today, people, especially young people working under pressure, have less time to take care of their health or even think about it, which often leads to health problems which should have been taken care of earlier. Illness or other disabilities are often the result of unawareness of health problems until it is too late.

Therefore, it is necessary to provide an electronic device and a warning method capable of overcoming the limitations described.

### BRIEF DESCRIPTION OF THE DRAWINGS

FIG. 1 is a block diagram of an electronic device, according to an exemplary embodiment.

FIG. 2 is a block diagram of a control unit of the electronic device of FIG. 1.

FIG. 3 is a flowchart of a method of generating warning information, according to an exemplary embodiment.

### DETAILED DESCRIPTION

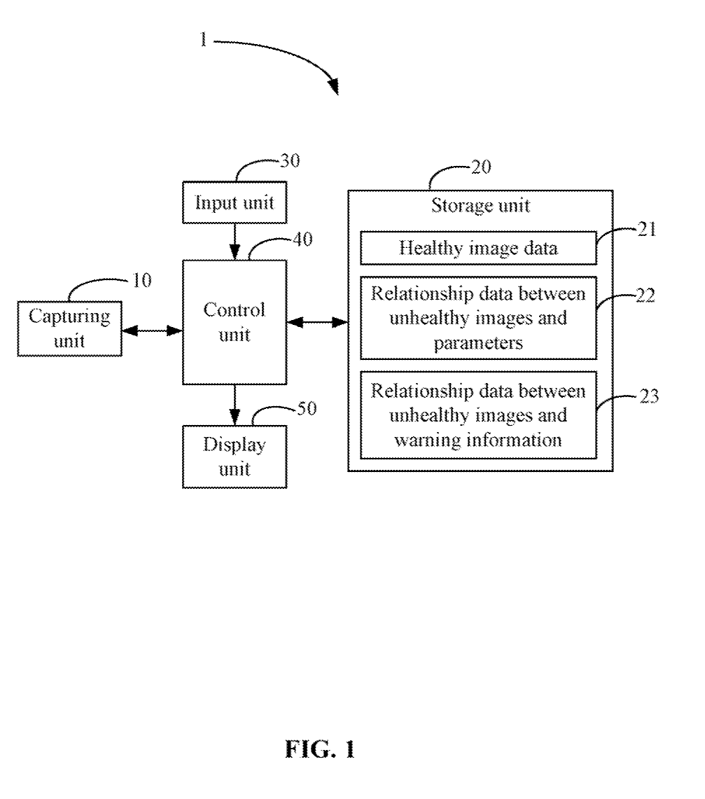

FIG. 1 is a block diagram of an electronic device, according to an exemplary embodiment. The electronic device 1 is portable and may be carried by a user, such as a mobile phone or a PDA. The electronic device 1 includes a capturing unit 10, a storage unit 20, an input unit 30, a control unit 40, and a display unit 50. The capturing unit 10 is configured for taking a photo, for example, taking a photo of one part of a user. The input unit 30 is configured for generating input signals in response to the input of a user. The control unit 40 is configured for controlling the electronic device 1. The display unit 50 is configured for displaying information.

The storage unit 20 includes healthy image data 21, relationship data between unhealthy images and parameters 22, and relationship data between unhealthy images and warning information 23. The healthy image data 21 is configured for storing good health images of all parts of the human body. Each healthy image is captured when the person in the image is healthy. In the embodiment, the capturing unit 10 can obtain the healthy images directly. In another embodiment, the healthy images can be obtained from an external storage device (not shown). The healthy images include, but are not limited to, a photo of a face, the eyes, a hand, or a foot.

The relationship data between unhealthy images and parameters 22 records unhealthy images of all body parts and parameters associated with the unhealthy images. The unhealthy images are the images of disorders and unhealthy conditions. The parameters include, but are not limited to, the size, the colors, and the number of rashes or other disorder visible on a body part, such as the size of a dark circle, the colors of the eyes, and the appearance of the facial and other complexion. The relationship data between unhealthy images and warning information 23 records the unhealthy images and warning information associated with the unhealthy images. The warning information is utilized to warn a user about his/her health condition according to the unhealthy image. For example, the storage unit 20 stores an unhealthy image, which has some dark circles in an ocular region thereof, and the warning information, which is defined “my friend, your nervous system requires attention, rest more to avoid a fatigue debt, get more sleep/improve and increase sleep quality.” In another embodiment, the storage unit 20 stores relationship data among unhealthy images, parameters, and warning information.

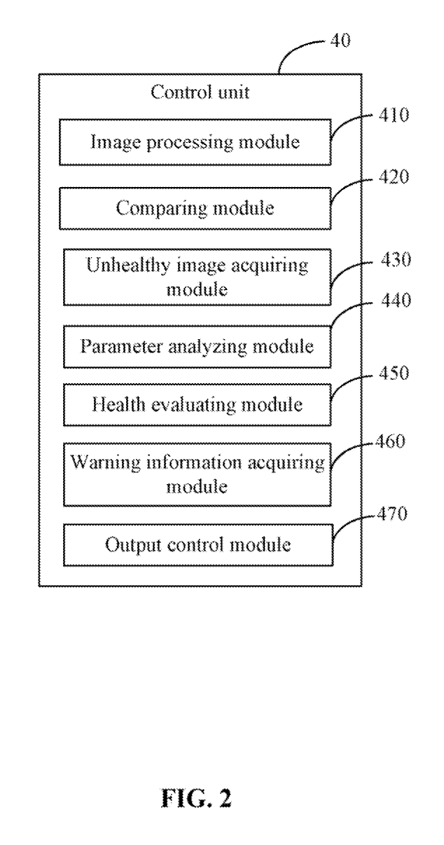

As shown in FIG. 2, the control unit 40 further includes an image processing module 410, a comparing module 420, an unhealthy image acquiring module 430, a parameter analyzing module 440, a health evaluating module 450, a warning information acquiring module 460, and an output control module 470. When the capturing unit 10 takes a photo of one part of a user in response to an input signal from the input unit 30, for example, taking a photo of an ocular region of the user, the image processing module 410 is configured for processing the photo to generate an image profile. The processing includes, but is not limited to, digital noise reduction, light and shade compensation, and resizing the photo.

The comparing module 420 is configured for comparing the image profile with the healthy images from the storage unit 20 to determine the body part the photo contains. For example, the image profile of the photo is about the eyes of the user and the comparing module 420 determines that the body part in the photo is about eyes. The unhealthy image acquiring module 430 is configured for acquiring an unhealthy image and the parameter of the unhealthy image based on the corresponding relationship data from the storage unit 20 according to the determined body part. For example, if the unhealthy image is about the eyes and the parameter of the unhealthy image includes the size and the color of the eyes, which may mean that the user has dark circles under the eyes.

The parameter analyzing module 440 is configured for analyzing the body part based on the image profile to obtain the parameter of the body part from the photo captured by the capturing unit 10, and comparing the parameter of the body part with the parameter of the unhealthy image to obtain a comparison value. For example, the size of the dark circles under the eyes of the user from the photo is a first predetermined value, the size of the dark circles in the unhealthy image is a second predetermined value, and therefore the comparison value is the difference between the first and the second predetermined values.

The health evaluating module 450 is configured for evaluating whether the comparison value falls within a predetermined range. When the comparison value falls within the predetermined range, the warning information acquiring module 460 is configured for acquiring warning information from the storage unit 20 associated with the unhealthy image based on the corresponding relationship data and the output control module 470 is configured for controlling the display unit 50 to display the warning information. For example, the warning information of the dark circles unhealthy image is described as follows: “you have dark circles under the eyes, please do eye exercises more often, massage around the eyes is advised, and you should have better foods, such as fish, carrots, lean meat, liver, and dry beans.”

Therefore, when the user of the electronic device 1 regularly uses the electronic device 1 to take a photo of his/her body parts, the electronic device 1 evaluates whether the body part of the user is healthy, if the body part is in an unhealthy state, the electronic device 1 displays the warning information concerning that the body part, so that the user may take remedial measures and improve his/her quality of life.

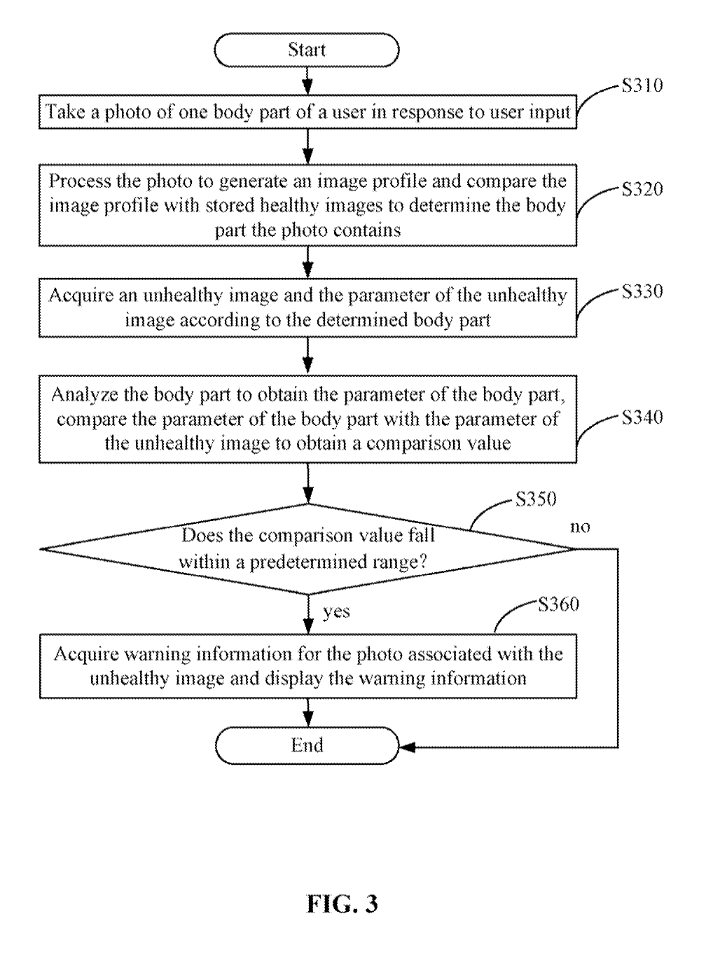

FIG. 3 is a flowchart of a method of generating warning information, according to an exemplary embodiment. In step S310, the capturing unit 10 takes a photo of one body part of the user in response to user input from the input unit 30. In step S320, the image processing module 410 processes the photo to generate the image profile and the comparing module 420 compares the image profile with the healthy images from the storage unit 20 to determine the body part the photo contains.

In step S330, the unhealthy image acquiring module 430 acquires the unhealthy image and the parameter of the unhealthy image based on the corresponding relationship data according to the determined body part. In step S340, The parameter analyzing module 440 analyzes the body part to obtain the parameter of the body part, comparing the parameter of the body part with the parameter of the unhealthy image to obtain a comparison value. In step S350, the health evaluating module 450 evaluates whether the comparison value falls within a predetermined range. If the comparison value falls within the predetermined range, in step S360, the warning information acquiring module 460 acquires the warning information for the photo associated with the unhealthy image based on the corresponding relationship data and the output control module 470 controls the display unit 50 to display the warning information.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for generating warning information, comprising:
a capturing unit for taking a photo;
a storage unit for storing healthy images of all body parts of the human body, unhealthy images of all body parts, and relationships among unhealthy images, parameters, and warning information;
an input unit for generating input signals in response to user input;
a display unit for displaying information; and
a control unit for processing the photo to generate an image profile when the capturing unit takes a photo of one body part of a user in response to an input signal from the input unit, comparing the image profile with the stored healthy images to determine the body part the photo contains, acquiring an unhealthy image and the parameter of the unhealthy image from the storage unit according to the body part, analyzing the body part to obtain the parameter of the determined body part, comparing the parameter of the body part with the parameter of the unhealthy image to obtain a comparison value, evaluating whether the comparison value falls within a predetermined range, and when the comparison value falls within the predetermined range, acquiring warning information of the photo from the storage unit associated with the unhealthy image and controlling the display unit to display the warning information.

2. The electronic device as recited in claim 1, wherein the parameter comprises the size, the color, and the number of rashes on the body part.

3. The electronic device as recited in claim 1, wherein the capturing unit can obtain the healthy images directly.

4. The electronic device as recited in claim 1, wherein the healthy images can be obtained from an external storage device.

5. A method for generating warning information by an electronic device, wherein the electronic device stores healthy images of all kinds of body parts of the human body, unhealthy images of all body parts, and relationships among unhealthy images, parameters, and warning information, the method comprising:
taking a photo of one body part of a user in response to user input;
processing the photo to generate an image profile and comparing the image profile with the stored healthy images to determine the body part the photo contains;
acquiring an unhealthy image and the parameter of the unhealthy image based on the corresponding relationship data according to the determined body part;
analyzing the body part to obtain the parameter of the determined body part, comparing the parameter of the body part with the parameter of the unhealthy image to obtain a comparison value;
evaluating whether the comparison value falls within a predetermined range; and
if the comparison value falls within the predetermined range, acquiring warning information of the photo associated with the unhealthy image based on the corresponding relationship data and displaying the warning information.

6. The method as recited in claim 5, wherein the parameter comprises the size, the color, and the number of rashes on the body part.

7. The method as recited in claim 5, wherein the electronic device can obtain the healthy images directly.

8. The method as recited in claim 5, wherein the healthy images can be obtained from an external storage device.
